(19) United States
(12) Patent Application Publication
(10) Pub. No.: US 2009/0289147 A1
(43) Pub. Date: Nov. 26, 2009

(54) METHOD OF COLLECTING INFORMATION RELATING TO A MOVABLE AIRFOIL SURFACE OF AN AIRCRAFT

(75) Inventors: Thomas Lavaud, Meudon (FR); Jean Clair Pradier, Houilles (FR); Bernard Baldini, Gradignan (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI, Velizy Villacoublay (FR)

(21) Appl. No.: 12/438,633

(22) PCT Filed: Jun. 5, 2008
(86) PCT No.: PCT/FR08/00760

§ 371 Date: Feb. 24, 2009

(30) Foreign Application Priority Data
Jun. 7, 2007 (FR) 0704090

(51) Int. Cl. B64D 15/22

(52) U.S. Cl. 244/134 F

(57) ABSTRACT

The invention relates to a method of collecting information relating to a movable airfoil surface (10) of an aircraft, the method including the step of collecting the information by means of an appropriate sensor placed directly on the airfoil surface. According to the invention, a radio type sensor is used that is placed on the airfoil surface so as to face a structure (1) of the aircraft that supports the airfoil surface and so as to be in contactless radio communication with a radio transceiver (20) disposed on said structure (1), regardless of the position of the airfoil surface relative to the surface, such that the sensor receives by radio from the transceiver the energy required for collecting the information and for returning a signal representative of the information by radio to the transceiver.

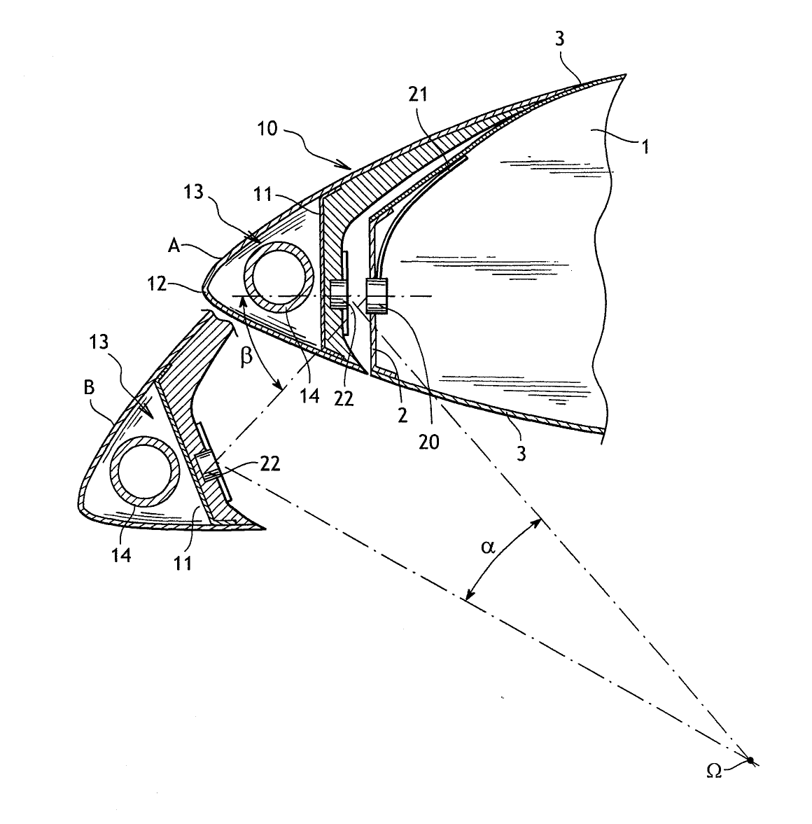

The invention relates to a method of collecting information relating to a movable airfoil surface of an aircraft.

### BACKGROUND OF THE INVENTION

On aircraft, certain high-lift elements, such as the leading edges of the wings, are liable to suffer from icing when certain atmospheric conditions occur. On airplanes of a certain size, the leading edges are provided with movable slats, and the slats are provided with means for protecting them against icing, e.g. heating resistor elements or indeed pipes for hot air taken from the jets and contributing to prevent ice forming on the slats.

The moves for providing protection against icing are activated when the ambient temperature lies within a certain range. It is found that under certain circumstances, the icing protection means are activated in unnecessary manner, since although ambient temperature lies in that range, conditions for ice formation on the leading edges are not satisfied.

Proposals have been made to place a temperature sensor directly on the movable slat in order to control the use of the icing protection means as a function of information about temperature taken as close as possible to the movable slat, thus making it possible to optimize the use of the icing protection means. In particular, the icing protection means can be activated only when the conditions that exist in the proximity of the movable slats are liable to give rise to icing.

Nevertheless, high-lift elements such as slats and flaps present the particular feature of moving a significant distance away from the wings when they are deployed, thereby complicating the connection with the sensor mounted directly on the high-lift element. Given the movements of the high-lift element relative to the wing, such a wire extending from the wing needs to present extra length, and that makes it necessary to use a member for guiding the wire mechanically between the wing and the high-lift element (e.g. articulated arms) in order to ensure that the wire does not hang down and is not blown about by the air stream. An example of such an installation is illustrated in document FR 2 874 370.

Document GB 2 293 522 discloses a contactless communication system between a stationary structure and a rotor. The rotor includes an electrical anti-icing device that is powered by power supply current generated in a coil that is secured to the rotor and that revolves in register with stationary permanent magnets. Sensors disposed on the rotor and powered by said current serve to collect information about the rotor (e.g. a temperature), which information is transmitted to the stationary portion via a contactless connection.

### OBJECT OF THE INVENTION

An object of the invention is to provide a method of collecting at least one item of information from the immediate environment of a movable airfoil surface in a simplified manner.

### BRIEF SUMMARY OF THE INVENTION

In order to achieve this object, the invention proposes a method of collecting information relating to a movable airfoil surface of an aircraft, the method including the step of collecting the information by means of an appropriate sensor placed directly on the airfoil surface. According to the invention, a radio type sensor is used that is placed on the airfoil surface so as to face a structure of the aircraft that supports the airfoil surface and so as to be in contactless radio communication with a radio transceiver disposed on said structure, regardless of the position of the airfoil surface relative to the surface, such that the sensor receives by radio from the transceiver the energy required for collecting the information and for returning a signal representative of the information by radio to the transceiver.

Thus, the sensor no longer needs to be connected by wires to a stationary portion of the aircraft structure, whether for power supply or for information transmission purposes. When information is required, the transceiver transmits a wave that is received by the sensor and that is converted into electricity for powering processor electronics of the sensor. The processor electronics acquires the information, calibrates it, and returns it in radio form to the transceiver, where the transceiver is disposed on the structure of the aircraft (e.g. a wing, a tail plane, or the tail fin) and can therefore be connected by wires or by a bus to a computer on board the aircraft.

No local power supply such as a battery, and no local generator is then needed, since the sensor receives its power directly from the transceiver by radio.

The use of radio technology thus enables information to be collected effectively from as close as possible to the airfoil surfaces of the aircraft.

### BRIEF DESCRIPTION OF THE DRAWING

The invention can be better understood in the light of the following description given with reference to the sole FIGURE of the accompanying drawing that shows an aircraft wing in fragmentary longitudinal section, showing a moving leading-edge slat in its retracted position and in its deployed position.

### DETAILED DESCRIPTION OF THE INVENTION

The invention is described below with reference to the sole FIGURE in an application to managing means for protecting a moving leading-edge slat of an aircraft wing against ice. It is clear that the invention is not restricted to this application.

The aircraft wing 1 shown is fitted at its leading edge with a slat 10 that is movable between a retracted position referenced A and a deployed position referenced B. The movable slat 10 passes from the retracted position A to the deployed position B by moving in rotation about a center omega (Ω) situated beneath the wing, through an angle alpha (α) of about 20 degrees. The mechanical elements that perform this rotation are not shown. They may be constituted, by example by curved slides.

In conventional manner, the wing 1 includes a leading-edge spar 2 co-operating with the covering 3 of the wing to form a torsion box. The leading-edge spar 2 extends in register with the movable slat 10.

The movable slat 10 includes its own leading-edge spar 11 having an airfoil profile 12 fitted thereon to co-operate with the leading-edge spar 11 to constitute a torsion box 13. Inside the slat 10 there extends a pipe 14 (seen in section) for conveying hot air taken from the aircraft jets. When protection against ice is required, a valve (not shown) serves to admit hot air into the pipe 14 in order to heat the slat 10 and thus prevent ice from forming thereon.

According to the invention, a radio transceiver 20 is disposed on the leading-edge spar 2, and thus on the fixed portion of the wing 1, facing the movable slat 10. The transceiver 20 is connected via a wire connection 21 to a computer (not shown) for controlling the means for providing protection against icing, and located in the fuselage of the aircraft.

The radio transceiver 20 is adapted to co-operate by radio waves with a temperature sensor 22 disposed on the movable slat 10 and facing the wing 1, and more specifically in this example directing facing the radio transceiver 20 when the movable slat is in its retracted position A.

The temperature sensor 22 has an antenna connected to processor electronics, in turn connected to a temperature probe proper. The temperature sensor 22 does not have any energy source of its own.

When the temperature information is required, the radio transceiver 20 emits a radio wave that is received by the antenna of the temperature sensor 22. The antenna transforms the radio wave into electricity for powering the processor electronics, which is then capable of reading the temperature signal coming from the probe, calibrating it as digital information, and transmitting this information via the antenna back to the radio transceiver 20. The transceiver then receives the calibrated temperature information and sends it to the controlling computer which, depending on the value of said information, activates and controls the icing protection means.

As can be seen in the FIGURE, when the movable slat is in its deployed position B, the temperature sensor 22 is no longer directly facing the radio transceiver 20. In this position, the temperature sensor is off-axis by an angle beta (β) of about 45 degrees and is located at a distance of about thirty centimeters from the transceiver 20. Nevertheless, the temperature sensor 22 remains within electromagnetic range of the radio transceiver 20, such that the temperature sensor 22 and the radio transceiver 20 can continue to communicate by radio. This naturally remains true in all intermediate positions of the movable slat 10 between its retracted position A and its deployed position B.

Placing the temperature sensor 22 directly on the movable slat 10 makes it possible to obtain information about temperature as it exists as close as possible to the moving slat 10, which is much more meaningful than temperature information taken from a sensor placed on the fuselage, for example, i.e. at a distance from the movable slat.

It should be observed that the temperature sensor 22 and the radio transceiver 20 are disposed in protected zones so they are not in danger of being reached by a projectile.

The invention is not limited to the above description, but on the contrary covers any variant coming within the ambit defined by the claims.

In particular, although the description is given with reference to protecting movable leading-edge slats against icing, the invention is not limited to that application. For example, it is possible to place an angle of incidence sensor on the movable slat in order to identify potential stalling of the aircraft. It is also possible to place an accelerometer or any other measurement means on flaps for the purpose of determining their angle of incidence and thus determining their position relative to the wing. These various sensors are preferably of the radio type having no energy source of their own.

Although the invention is particularly adapted to high-lift devices that move towards or away from the wing, the invention applies more generally to any movable airfoil surface fitted to an aircraft, whether to a wing, a tail plane, the tail fin, . . . .

1. A method of collecting information relating to a movable airfoil surface (10) of an aircraft, the method comprising the steps of collecting the information by means of an appropriate sensor placed directly on the airfoil surface, and of using a radio type sensor that is placed on the airfoil surface so as to face a structure (1) of the aircraft that supports the airfoil surface and so as to be in contactless radio communication with a radio transceiver (20) disposed on said structure (1), regardless of the position of the airfoil surface relative to the surface, such that the sensor receives by radio from the transceiver the energy required for collecting the information and for returning a signal representative of the information by radio to the transceiver.

2. A method of managing protection against icing of at least a movable leading-edge slat (10) mounted to move relative to an aircraft wing (1), the slat being provided with controlled icing protection means (14), the method comprising the step of causing said icing protection means to operate as a function of a temperature measurement performed in the vicinity of the movable slat performed with the help of at least one temperature sensor (22) placed directly on the movable slat so as to be in contactless radio communication with a radio transceiver (20) placed on the wing (1), and regardless of the position of the movable slat relative to the wing.
